(19) United States
(12) Patent Application Publication
(10) Pub. No.: US 2019/0118921 A1
(43) Pub. Date: Apr. 25, 2019

(54) Outboard Motor Midsection comprised of a Constant-Profile, Airfoil-Shaped Extrusion

(71) Applicant: Neal Drapeau, Windham, NH (US)

(72) Inventor: Neal Drapeau, Windham, NH (US)

(73) Assignee: Neal Drapeau, Windham, NH (US)

(21) Appl. No.: 15/793,964

(22) Filed: Oct. 25, 2017

(51) Int. Cl. B63H 20/34

(52) U.S. Cl. CPC B63H 20/34; F02B 61/045

(57) ABSTRACT

A structural tube within a marine propulsion system directly provides steering functionality from its interaction with the water and houses hardware used to transmit power from the engine to the propeller shaft. Said invention comprises a long, hollow, tube of constant cross section, the exterior profile of which takes the shape of an airfoil.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

The invented midsection under consideration pertains to the field of Marine Propulsion technology, Class 440. More specifically, the invented midsection can be classified as a Propulsion Unit Casing, Subclass 76. The device is physically situated between the engine and lower unit on an outboard motor style propulsion system. It serves as a passageway for power transmission elements, a structural member, and a steering mechanism. The invented midsection is designed to be a superior alternative to the midsection castings ubiquitously seen on outboard motors sold by established companies in the industry.

The aforementioned midsection castings maintain a similar construction between brands and models. This construction exhibits several deficiencies worth addressing. Most notably, this style of midsection has a complex geometry which varies continuously across the extents of the part. Because of this, the parts are limited to manufacture through casting and molding processes, which are the only feasible options for producing such large, difficult shapes in production quantities. While casting has been the long-standing method for producing midsections, the process is not preferable to other methods which are more cost effective and otherwise superior. Processes such as extrusion and sheet metal forming offer many advantages relative to casting such as shorter production times, better resulting material properties, and reduced post processing effort. These methods are not feasible with the complex geometry of the prevailing midsection designs.

Another problem stemming from the complex geometry of cast midsections is the lack of practical scalability in the length direction. Manufacturing multiple lengths of such a complex part is difficult. Even if the molds are easy to modify, as is sometimes the case for sand casting processes, there are numerous post machining, handling, and validation processes that become complicated. Each of these subsequent processing steps requires a unique fixture for each length, creating a large cost and effort burden. To simplify processing multiple lengths, the midsection could instead be designed with certain geometrical features that remained constant across length permutations. When designed as such, it would be possible to handle all permutations with a single fixture at each step. This would make the overall manufacturing significantly easier.

Lastly, a significant disadvantage of cast midsections as they exist is the inability to provide any kind of steering functionality. In outboard motors with cast midsections, the steering functionality must come from the lower unit. When steering related structures are added to the lower unit, the resulting part geometry is complex. The manufacturing of the lower unit is then restricted to casting processes, which are subject to the same inferiorities mentioned earlier related to the manufacture of cast midsections. If steering functionality could instead be moved from the lower unit to the midsection, the accompanying lower unit could be designed with a much simpler geometry. The simplified lower unit could then be manufactured using a variety of processes superior to casting. It should be noted that adding steering functionality to the midsection does not necessarily make it more complicated. It is possible to design a steerable midsection in such a way that it can still be manufactured using the superior processes mentioned in the paragraphs above.

### SUMMARY OF THE INVENTION

The invention under consideration is an outboard motor midsection which is designed in a novel way to address the aforementioned issues with currently existing devices. As stated, the root of the manufacturability and scalability issues on existing midsection castings is their complex geometry. To address this, the invented midsection is designed with a geometry that is both highly manufacturable and functionally improved. The following paragraphs discuss the advantages of the invented midsection and the changes made relative to prevailing designs.

The first major advantage of the invented midsection is its ability to be manufactured using processes other than casting. This is accomplished by designing the invented midsection with a uniform cross section. On conventional midsections, the cross section varies continuously as it progresses from the propeller end to the engine end. On the invented midsection, the cross section is exactly the same at the propeller end as it is at the engine end. The switch to a uniform cross section opens up new options for manufacturing, the most practical of which is extrusion. This process is far superior to casting in terms of cost, speed, final mechanical properties, and required post processing.

The second major advantage of the invented midsection is its ability to be manufactured in multiple lengths with the same equipment and tooling. This advantage, like the first, is enabled by the uniform cross section; the cross section would remain exactly the same for the various lengths produced. The initial formation of multiple length permutations during the extrusion step is trivial; this simply involves cutting the monolithic extruder product to the desired lengths. In the steps following extrusion, a novel approach can be used for fixturing the midsection: a sleeve type fixture designed to fit around the tube exterior can be used to handle all lengths. This length insensitive style of fixture would make the post processing steps much easier; without a universal style fixture, these operations would require separate tooling for each length permutation. The use of a length insensitive type of fixture is contingent on all length permutations having an identical cross section, as described.

The most significant advantage of the invented midsection is the ability to directly provide steering functionality. By utilizing an airfoil shaped exterior profile and by extending the length of the midsection into the free stream of water beneath the boat, the device serves as a steering mechanism for the propulsion system.

The airfoil shaped exterior makes the steering functionality possible in two ways. The first way is that the airfoil shape minimizes the drag force caused by the water stream passing across the midsection. If the blocky exteriors of conventional midsections were extended into the free stream, the drag forces would be enormous, making the system prohibitively inefficient. The airfoil shaped exterior on the invented midsection minimizes flow disruption and lowers the drag forces to a reasonable level. The second way the airfoil shape enables steering is by creating enormous lateral steering forces when the midsection is pivoted in the free stream. Conventional blocky midsections would produce subtle and unreliable steering forces if employed in a similar manner. The invention's airfoil shaped exterior efficiently induces a lateral velocity component to the passing water, producing substantial lateral forces to steer the boat.

The practical advantage of adding steering functionality to the midsection is that the same steering functionality can then be removed from the lower unit. Once steering structures are removed from the lower unit, the geometry is simplified. The simplified lower unit can be made using manufacturing methods superior to casting.

### BRIEF DESCRIPTION OF THE DRAWINGS

FIG. 1 is a view of the invented midsection in isolation.

FIG. 2 is a view of the cross section of the invented midsection detailing the internal features.

FIG. 3 shows the invented midsection as part of an outboard motor assembly in one potential configuration.

FIG. 4 shows the invented midsection within an outboard motor assembly attached to a boat, demonstrating the extension of the midsection below the boat bottom to provide steering functionality.

FIG. 5 shows the invented midsection held by a tooling fixture for a welding process, demonstrating the type of sleeve type tooling that can be utilized in post processing operations to accommodate multiple extrusion lengths

### DETAILED DESCRIPTION

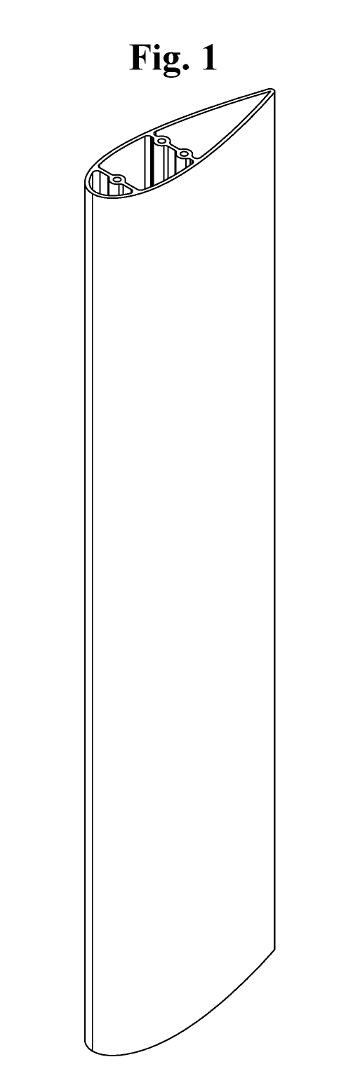

The basic form of the invented midsection is detailed in FIGS. 1, 2, 3. Starting with FIG. 1, the invented midsection is seen in isolation. In this view, the general proportions of the invented midsection are evident, and the airfoil profile of the exterior is visible. The end of the extrusion is exposed, showing some of the interior features of the cross section.

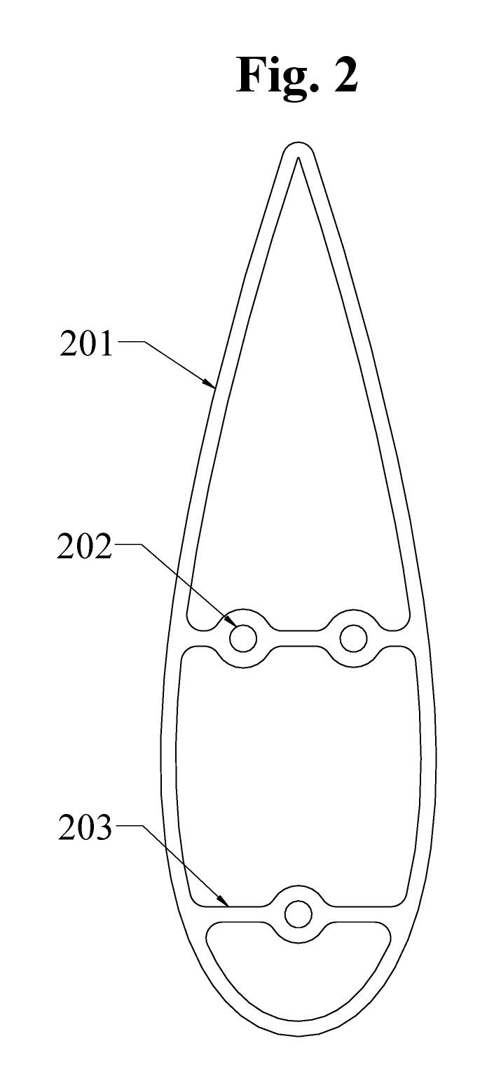

In FIG. 2, a detailed view of the extrusion cross section is provided. The airfoil shaped exterior profile 201 defines the outermost wall of the extrusion. In addition to providing the steering functionality discussed earlier, the exterior wall creates the bulk of the flexural rigidity afforded by the extrusion. The cross section also includes several fully enclosed circular holes 202 which serve as alignment features for manufacturing fixtures. These holes also have the potential to be tapped with machine screw threads if necessary to accommodate screws in an outboard motor assembly. The positioning of the holes is application dependent and can be arranged to satisfy particular design requirements. Webbing features 203 provide mechanical support to said holes. The webbing features also provide crush resistance to the exterior of the tube, offer a modest amount of flexural rigidity, and isolate the cavities within the interior of the cross section from each other. The cavities provide spaces to route hardware related to the associated outboard motor assembly. By isolating the cavities from each other, various mutually exclusive environments can be maintained. For example, one cavity could be flooded with lubrication while another remained dry, allowing for components to be installed requiring each condition.

The first advantage of the invented midsection, as discussed extensively in the summary, is the ability to use extrusion manufacturing processes instead of casting. This change is facilitated by the invented device's uniform cross section, which is a prerequisite to using extrusion processes. By switching the process from casting to extrusion, many benefits are realized, including a reduction in cost, an increase in production speed, better mechanical properties, and reduced post processing effort. Because conventional midsections have a variable cross section, they are inherently unable to utilize extrusion processes, unlike the present design.

Of the many materials from which the invented midsection could be extruded, the most practical would be a member of the 6000 series aluminum alloys. These alloys are strong, lightweight, corrosion resistant, and easy to extrude. The particular alloy within this series, as well as the particular temperature and machine configuration, would be selected based on application specific design requirements such as strength, ease of extrusion, and cost. A wide range of process parameters is anticipated to be suitable while still producing an acceptable end result. The extrusion of 6000 series aluminum alloys is a commodity process which is performed by many vendors across the globe, and is universal enough that consistent results can be expected from any properly equipped manufacturer.

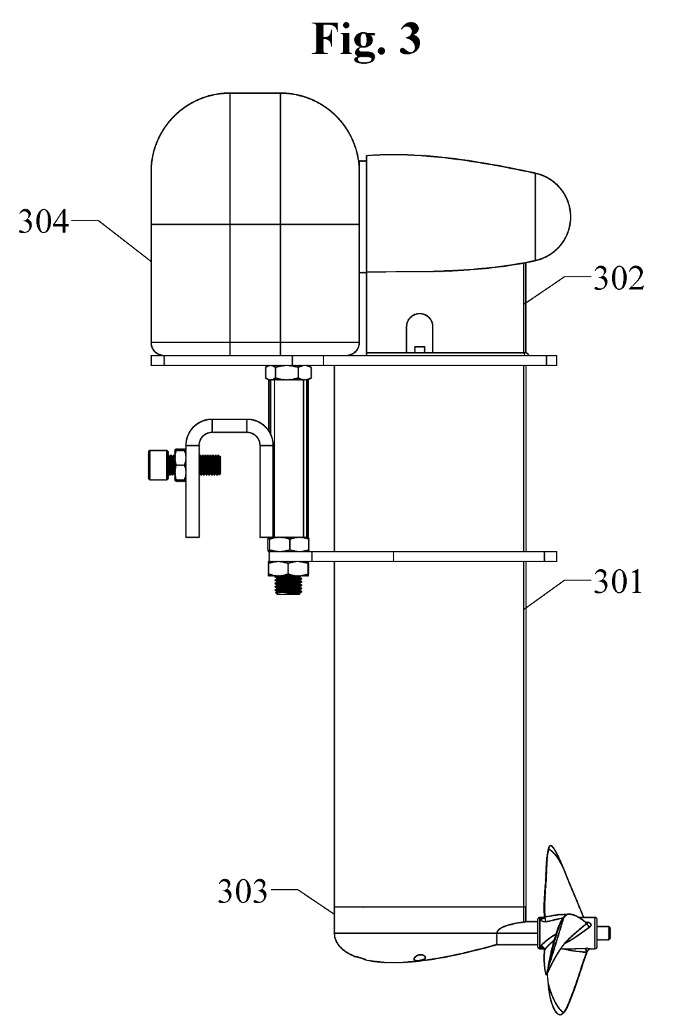

FIG. 3 shows the invented midsection in the context of a potential outboard motor configuration. The invented midsection 301 is seen interposed between a rotary power source 304 and a lower unit 303, which houses the propeller shaft. Item 302 is a shroud, which is identified only to differentiate it from the midsection 301 since they have a similar appearance. The most important function of FIG. 3 is to demonstrate how the lower unit 303 can be simplified after the invented midsection 301 is implemented. As described earlier in the disclosure, the addition of steering functionality onto the midsection allows steering structures such as skegs to be removed from the lower unit. This greatly reduces the size and complexity of the geometry on the lower unit. The lower unit 303 in FIG. 3 shows the potential simplicity and compact size of this component once steering functionality is removed.

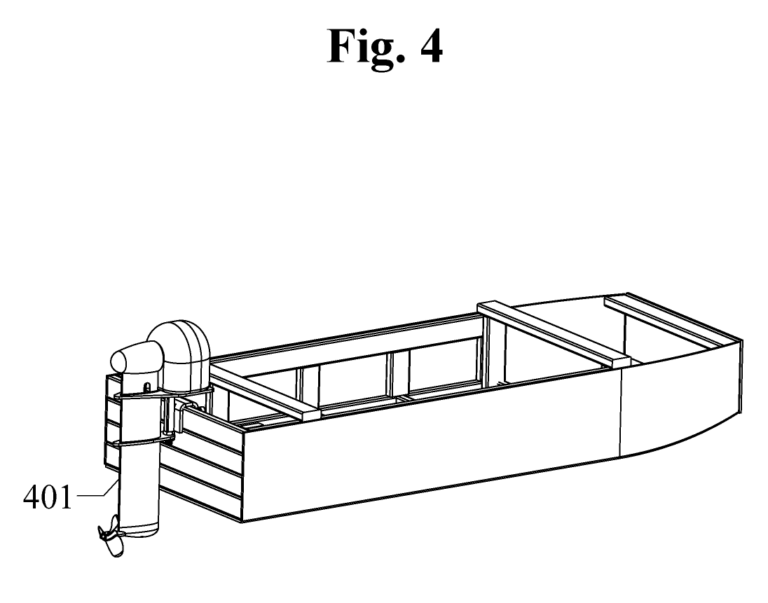

FIG. 4 shows the invented midsection 401 as part of an outboard motor assembly, which is mounted onto the transom of a skiff. As can be seen, the midsection extends below the bottom of the boat into the free stream of water. When configured as shown the midsection receives ample water flow past it, and functions as the outboard motor's steering mechanism as introduced earlier.

This steering functionality is the most valuable benefit afforded by the invented midsection. As mentioned in the summary, this functionality is achieved by shaping the midsection exterior as an airfoil and by extending the midsection all the way into the free stream of water below the boat. The airfoil shape minimizes drag forces, and provides large lateral steering forces when the midsection is pivoted in the water stream.

The characteristic function of airfoil shapes in their application is to minimize force in the direction opposite of travel, and to controllably produce force in the perpendicular direction. This functionality occurs when moving through a fluid. For the invented midsection, the use of the airfoil shape is somewhat unusual; traditionally, airfoils are oriented such that the deliberately produced forces point in the skyward direction in order to counteract gravity. In this application the deliberately produced forces are pointed in the starboard and port directions relative to the powered watercraft, in order to steer the vessel.

The practical advantage of having steering functionality on the midsection is the ability to eliminate this functionality from the lower unit. By removing steering structures from the lower unit, the part becomes much smaller and simpler, as seen in the suggested lower unit design from FIG. 3, item 303. The geometric simplicity of the non-steerable lower unit enables superior manufacturing methods to be used when making it. The feasible methods include die-casting, plastic injection molding, and CNC milling, to name a few, all of which produce results superior to the casting processes typically required to produce steerable lower units. As mentioned before, the addition of steering functionality onto the midsection does not add any complexity to its manufacturing process; extrusion is still feasible.

It is necessary to note that the term “airfoil” in the entirety of this disclosure and in the subsequent claims is defined as a shape which resembles a teardrop 201 that produces the dynamic forces as described in paragraph [0027] when moving through a fluid. The words “foil” and “hydrofoil” were considered as alternatives to the term “airfoil” since “airfoil” has several possible connotations. The word “foil” was forgone because of its many possible meanings and lack of universal understanding as a shape with the described dynamic properties. “Hydrofoil” was forgone because of the word's generally understood meaning as a specific wing-like device to lift a ship's hull out of the water.

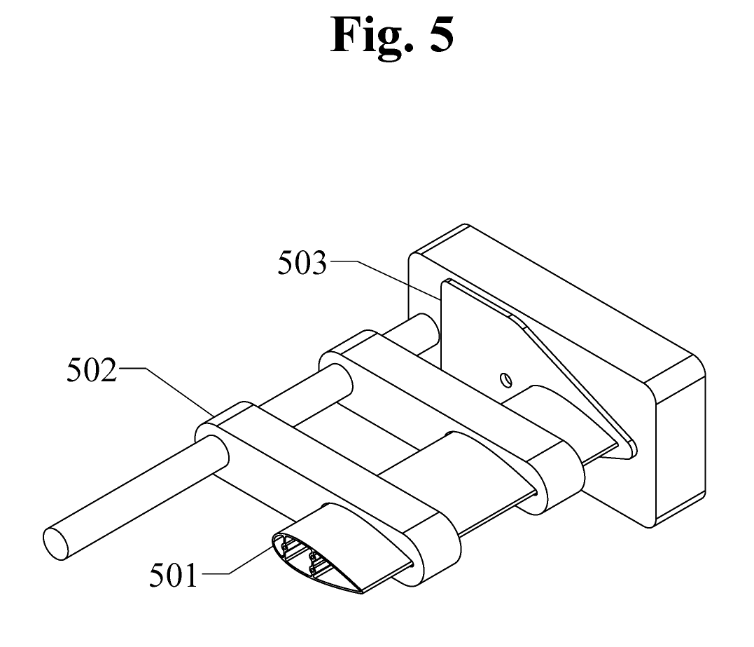

FIG. 5 shows the invented midsection 501 fixed against a structural plate 503 during a welding process in the creation of a potential outboard motor assembly. The figure highlights a sleeve type tooling 502 that can be utilized during post-processing and assembly steps to fixture the midsection as required. This particular style of sleeve type tooling is length independent, meaning that multiple extrusion lengths can easily be accommodated by a single fixture at each processing step.

This ability to use length insensitive fixturing affords the last main advantage of the invented midsection, the ability to easily manufacture multiple length permutations of the same midsection cross section. As described in the invention background section, the complex cross section of conventional midsections makes it difficult to manufacture multiple lengths. In order to do so, unique molds designs are necessary for each length during the casting operation. Subsequent to the casting process, unique fixtures are required for each length during the post processing steps. In the case of the invented midsection, the manufacture of multiple length permutations is extremely easy. During the initial extrusion operation, the creation of different length midsections is trivial—they are simply cut to the desired lengths from the single large extrusion produced by the extruder. Subsequent to the initial formation, fixturing of the various lengths during the post processing and assembly steps can easily be accomplished through the use of sleeve type tooling, as described in the previous paragraph. Only a single tooling assembly of this sleeve type is required at each processing station to handle all the length permutations being manufactured.

1. A device within a watercraft propulsion system comprising a tube with an airfoil shaped exterior profile of constant cross section, which contains at least one hollow cavity, which is manufactured using an extrusion process, and in its application contains power transmission hardware routed through its cross section.

2. (canceled)

3. (canceled)

4. (canceled)

5. (canceled)

6. (canceled)

7. (canceled)

8. (canceled)

9. (canceled)

10. (canceled)

11. (canceled)

12. (canceled)
